(19) United States
(12) Patent Application Publication
(10) Pub. No.: US 2008/0193209 A1
(43) Pub. Date: Aug. 14, 2008

(54) Fastener For Connecting Components and Assembling Embodying Same

(76) Inventor: Pieter M. Henderson, Johannesburg (ZA)

Correspondence Address: KNOBBE MARTENS OLSON & BEAR LLP, 2040 MAIN STREET, FOURTEENTH FLOOR, IRVINE, CA, 92614, US

(21) Appl. No.: 11/910,414

(22) PCT Filed: Feb. 17, 2006
(86) PCT No.: PCT/IB2006/000323

§ 371 Date: Oct. 1, 2007

(30) Foreign Application Priority Data
Mar. 29, 2005 (ZA) 2005/02481

(51) Int. Cl. F16B 12/14; F16B 12/46; F16B 5/02

(52) U.S. Cl. 403/297; 403/388

(57) ABSTRACT

A fastener element (7, 24, 30, 41, 50, 60) is adapted to be secured in a blind hole (12) formed in a first component (13) to be connected to a second component (14) generally provided with an aligned blind hole. The element is of generally cylindrical shape with an outer surface provided with a series of anchoring formations (10, 32, 43) following a generally helical path along at least a part of its length. The formations are configured to enable the element to be forcibly introduced, at least partially, without rotation thereof axially into a blind hole in said first component to anchor the element therein. The fastener element either has a shank permanently associated therewith (7) or one or more formations (34, 43, 45) for the operative retention of a cooperant end of a separate shank (36, 43). The shank has an engagement zone (9, 22, 23, 37, 42, 71) whereby rotation of the element can be effected about its axis to result in axial movement of the element relative to the hole to tighten a joint. The invention also provides components and a method of joining them using the fasteners.

### FIELD OF THE INVENTION

This invention relates primarily to a fastener that is suitable for use in interconnecting components, particularly, but not exclusively, furniture components, either in a releasable or a permanent manner. More particularly, the invention is concerned with a fastener that can generally be substantially concealed in that it requires an access aperture that can itself generally be located away from normally visible faces or edges of the components being secured together.

The invention also relates to components, in particular furniture components, that are adapted to be secured to other components by means of fasteners of this invention as well as to completed assemblies of such components.

The invention still further relates to a method of assembling components, in particular furniture components, utilising fasteners of the invention.

### BACKGROUND TO THE INVENTION

A variety of different fasteners are available for connecting components, in particular furniture components, together. Such fasteners include wood screws, self tapping screws, machine screws (usually in combination with co-operating nuts) and the like. There is in use certain cam action locking devices that are typically used in relation to furniture of a “knock-down” type.

In at least most cases access apertures are required in one or other normally visible face of the components. Such access apertures must then be closed with plugs, caps, filler material or other cover means.

The problem of access apertures may be obviated by using wooden or like dowels that are adhesively or otherwise secured into aligned blind holes in the components being secured together. When using adhesive it is generally necessary to clamp the two components together firmly for a significant period of time whilst the adhesive sets in order to result in a neat, closed and strong joint. Such clamping is not only time consuming but also restricts the progress of assemblies of components through a production line and delays further stages of treatment of the partly or fully assembled articles, typically of furniture. This method of assembly is clearly inappropriate in instances in which components are required to be capable of disassembly.

### OBJECT OF THE INVENTION

It is an object of this invention to provide a fastener that can be employed more advantageously than those mentioned above and that can generally be employed without access apertures in normally visible faces of components being connected together.

It is another object of the invention to provide components having blind holes for cooperating with a fastener of the invention and, in appropriate instances, recesses for forming an access aperture for accessing a fastener during assembly of such components.

It is yet another object of the invention to provide a method of assembling components utilising fasteners of the invention.

### SUMMARY OF THE INVENTION

In accordance with a first aspect of this invention there is provided a fastener element adapted to be secured in a blind hole formed in a first component to be connected to a second component and wherein the element is of generally cylindrical shape with an outer surface provided with a series of anchoring formations extending along at least a part of its length and wherein the formations are configured to enable the element to be forcibly introduced, at least partially, without rotation thereof, axially into a blind hole in said first component to anchor the element therein, the fastener element either having a shank permanently associated therewith or one or more formations for the operative retention of a cooperant end of a separate shank, the fastener element being characterised in that the anchoring formations follow a generally helical path and in that an engagement zone is provided on the element or a shank associated therewith for engagement by a tool whereby rotation of the element about its axis can be effected to cause said anchoring formations to follow a helical path in the blind hole with resultant axial movement of the element relative to the hole to move the element axially in the hole.

In a first variation of the invention a fastener comprises a shank having a first end region provided with an element as defined above permanently associated therewith and a second end region of the shank provided with at least one retaining formation configured to enable the second end region to be anchored in a blind hole in a second component in order to join the said first and second components together. The second end region may be provided with a second fastener element as defined above wherein the helical path is of opposite hand or of at least significantly different pitch to that of the first; a retaining formation in the form of a head held axially relative to a second plug for anchoring in a hole in a second component but wherein the shank is rotatable relative to the second plug; a retaining formation in the form of a conventional machine screw-thread (generally of opposite hand to any helically extending formation on the said first end of the shank and capable of cooperation with, for example, a nut welded or otherwise secured relative to a second component of metal for example); a retaining formation in the form of a radially extending formation co-operating with a cam surface on the inside of a plug in a hole (generally blind) in a second component.

In the first variation of the invention the engagement zone may be one or more formations either integral with the anchoring formations on the element, or alternatively, an exposed part of an elongate insert onto which material is moulded in order to form the anchoring formations in which case the elongate insert is preferably configured for engagement by a cooperant tool and for this purpose may be of noncircular shape in cross-section such that the exposed region thereof defines said engagement zone.

In a second variation of the invention the fastener element assumes the form of a plug for installation in a blind hole in a component and in that instance the engagement formations are preferably one or more formations in a face thereof that is to be exposed at the mouth of the blind hole. Such one or more formations may be a polygonal, in particular hexagonal or square, socket formed at an entry mouth to a socket that has formations, such as a screw thread, or deformable projections configured to retain a cooperating end of a shank therein. In the instance of deformable projections, these may assume the form of a substantially continuous helical formation of saw-tooth shape but, in this case, with the saw tooth shape preferably providing an undercut to render the formation capable of flexing to a somewhat flattened condition as another set of formations is urged axially past them. It is also contemplated that the socket of the plug and, optionally also, any series of formations, may taper slightly so as to urge the formations into firm contact with those on a shank introduced therein or to cause the plug to expand into firm engagement with a hole in which is located during installation of a fastener therein, or both.

Further features of the invention provide for the anchoring formations to be configured for cooperation with the walls of blind holes drilled in somewhat soft or deformable material, in particular wood and reconstituted wood materials, in which case the anchoring formations may either be formed as somewhat deformable plastics formations, typically a suitable nylon material or even a moulding of compressed subdivided wood with a suitable binder or adhesive, or the fastener element may be made as a rigid component typically of metal; for the anchoring formations to be a series of convolutions of a continuous or preferably discontinuous helical formation of generally saw tooth shape in longitudinal section such that the sharp edges tend to bite into the said wall of a blind hole; for the series of convolutions to be discontinuous by virtue of longitudinally extending grooves formed in the outer surface of the fastener element; and for the saw tooth shape, in the case that it is made of a plastics material, to be configured such that the sharp edge region thereof is capable of flexing inwards to at least slightly reduce the diameter thereof during axial forcible installation into an appropriately sized blind hole such that a force tending to withdraw the series of formations axially from a hole tends to urge the sharp edges into tighter engagement with the wall of the hole.

In use, a composite fastener according to this invention is to be installed in axially aligned, generally blind, holes in two components, typically furniture components for example, which are to be connected together. A fastener element or the first end region of a fastener as the case may be is introduced into a blind hole provided in one of the furniture components and a second fastener element or the said second end of the shank of a fastener is to be received in a generally blind hole of a second component.

The fastener element or first end region of a fastener is simply introduced, at least partially, into the first mentioned hole by forcing it axially therein and, before, after, or roughly at the same time, the said second fastener element or end of the shank is anchored relative to said second hole. Tightening can then be effected by rotating the shank by means of the engagement zone to cause the said first, and in appropriate instances, the second end region as well, to move further into the socket thereby tightening the joint.

All that is required of a furniture component in order to enable such tightening to take place is a recess in an end edge of a component such that the fastener receiving hole is located within the surface area covered by the recess or hole. The recess or hole then provides an access aperture located at an inner corner of the assembled components that is not normally visible. Such an access aperture enables a spanner or other appropriate tool to be engaged with the engagement zone of the shank to rotate it.

Such components, as well as assemblies thereof are intended to fall within the scope of this invention as separate items of commerce.

In accordance with a second aspect of the invention there is, accordingly, provided a method of assembling components in which two components to be joined are provided with appropriate aligned holes for receiving a fastener element or an end region of a fastener having a series of formations wherein at least one of such components is provided with a recess or hole for defining an access aperture in the assembled condition, the method comprising installing fastener elements or fasteners as defined above in said aligned holes and tightening the resultant joint by rotation of the fastener, in each case by engaging a tool with said engagement zone by way of the access aperture.

Further features of this aspect of the invention provide for the two components to have additional conventional aligned holes for receiving conventional dowels in which case the method involves the application of adhesive, as may be required, and assembly of the components using fasteners of this invention to urge the components into firm engagement with each other so that curing of the adhesive may take place.

It will be understood that in the latter instance the fastener element and fasteners of this invention can be used at spaced positions that are only adequate for holding the components together whilst the adhesive cures thereby obviating the need for clamps to hold components together over the period of time that curing of the adhesive takes place. Production of assemblies of components that are glued together in substantially conventional manner can thereby be expedited and facilitated with the aid of a limited number of fasteners according to the invention that are used predominantly in place of clamps.

In order that the above and other features of the invention may be more fully understood, various embodiments of the different aspects and variations thereof will now be described with reference to the accompanying drawings.

### BRIEF DESCRIPTION OF THE DRAWINGS

In the drawings:

FIG. 1 illustrates schematically, in isometric view, as a typical item of furniture, a desk that can be assembled using fasteners according to the invention;

FIG. 2 is a schematic front elevation of a cupboard having sidewalls and top and bottom walls that can be assembled using fasteners according to the invention;

FIG. 3 is an isometric view of a first embodiment of fastener having a shank with two like but oppositely handed end regions;

FIG. 4 is a sectional view illustrating the fastener of FIG. 3 in an operative position relative to two furniture components;

FIG. 5 is an underneath isometric view illustrating the joint of FIG. 4 and showing the access recess for a tool for tightening the fastener;

FIG. 6 is a view showing a tool such as is partly illustrated in FIG. 5;

FIG. 7 illustrates, in isometric view, the recessed zone of one end edge of a furniture component;

FIG. 8 is an isometric view of a second embodiment of fastener having a shank with two like but oppositely handed end regions;

FIG. 9 is an isometric view from the other end of the fastener illustrated in FIG. 8;

FIG. 10 is an end view thereof showing the configuration of the grooves;

FIG. 11 is a view similar to FIG. 8 showing a differently configured engagement zone;

FIG. 12 is a view similar to FIG. 8 showing a further variation of engagement zone;

FIG. 13 is a view similar to FIG. 8 showing a fastener having a shank produced from an extruded section;

FIG. 14 is a cross-section of the extruded section employed to produce the fastener illustrated in FIG. 13;

FIG. 15 is a sectional view similar to FIG. 4 but illustrating a shank and separate fastener elements in the form of plugs according to the second variation of the invention;

FIG. 16 is an isometric view from the operatively inner end of one embodiment of fastener element in the form of a plug;

FIG. 17 is an isometric view taken from the operatively outer end thereof;

FIG. 18 is an enlarged view of a somewhat different plug and co-operating end of a shank of a fastener assembly;

FIG. 19 is a more enlarged detail illustrating the form of the co-operating helical formations of the plug and shank illustrated in FIG. 18;

FIG. 20 is an isometric view of a fastener suitable for use with a plug as illustrated in FIGS. 15 and 16;

FIG. 21 illustrates, in isometric view, a plug unit in one form in which it can be manufactured;

FIG. 22 illustrates, in sectional elevation, an embodiment of the invention in which the second end region of the fastener is anchored by a first alternative arrangement;

FIG. 23 illustrates, in sectional elevation, an embodiment of the invention in which the second end region of the fastener is anchored by a second alternative arrangement;

FIG. 24 is a front elevation of the plug of the embodiment illustrated in FIG. 23;

FIG. 25 is a sectional view taken along line XXV-XXV in FIG. 24; and,

FIG. 26 illustrates, in sectional elevation, an embodiment of the invention in which the second end region of the fastener is anchored by a third alternative arrangement.

### DETAILED DESCRIPTION WITH REFERENCE TO THE DRAWINGS

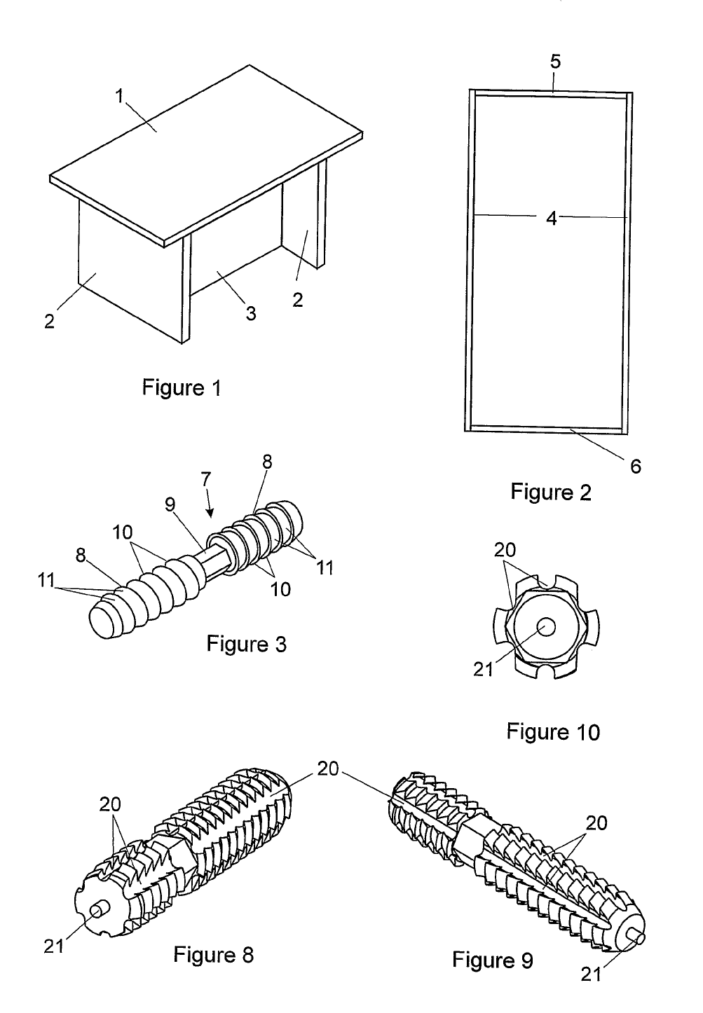

Whilst not being limited to such application, fasteners according to the invention are especially suitable for use in assembling furniture components to form finished articles of furniture. For example, the fasteners of this invention can be employed for securing panels together that typically extend at right angles to each such as a desk top (1) (see FIG. 1) and two leg defining panels (2) as well as for securing a modesty panel (3) to the leg defining panels. The panels could also be, for example, the sidewalls (4) and the top and bottom walls (5) and (6) of a cupboard (see FIG. 2).

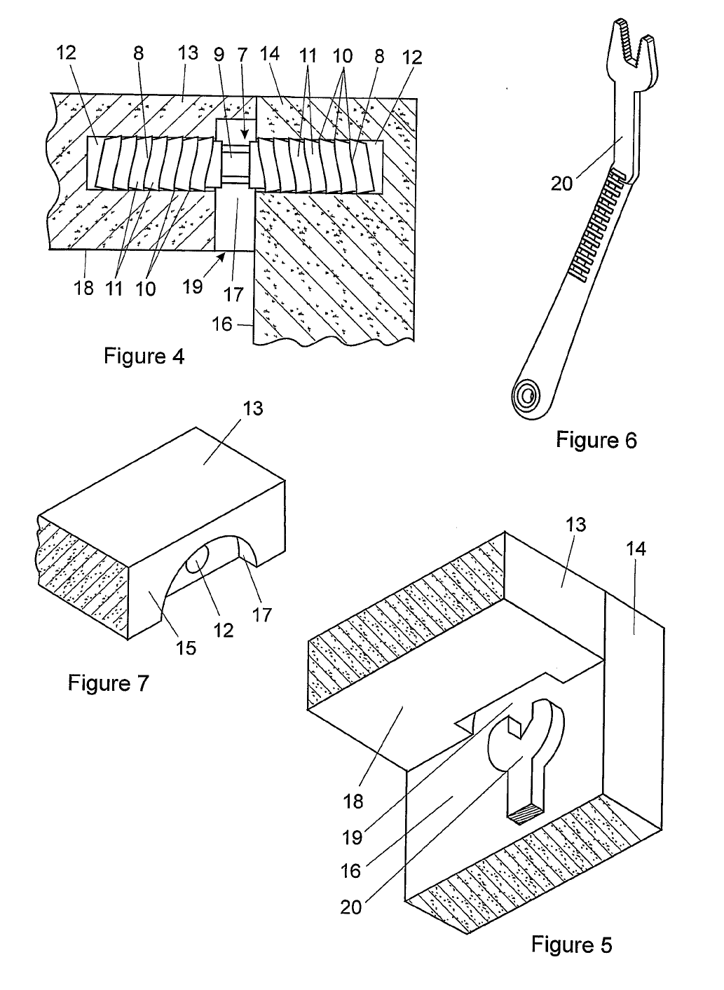

Turning now to a simple embodiment of the invention that is illustrated in FIGS. 3 and 4, a fastener according to the first variation defined above, generally indicated by numeral (7), consists of two coaxial end regions (8) interconnected by a central hexagonal cross-sectioned engagement zone in the form of a hexagonal formation (9). Each of the end regions is injection moulded from a suitable plastics material, typically an appropriate nylon or other optionally fibre reinforced plastics or resinous material that may be filled, typically with subdivided wood.

Each of the end regions has an outer surface defined by a series of convolutions of a helical ridge of sharp edged saw-tooth configuration with the sharp edge (10) of the saw tooth directed towards the central engagement formation (9) and the inclined surfaces (11) of the ridge directed towards the free end. This arrangement facilitates axial introduction of the end region into a somewhat undersized blind hole (12) drilled in a component (13, 14), typically of chipboard or other reconstituted timber. The helical ridge on the two end regions is of opposite hand.

The fastener described above could be made either as a one-piece plastics injection moulding in which case the engagement formation may require that the plastic be suitably reinforced or it could be made with plastic end regions moulded as covers onto an insert of say hexagonal steel rod the central portion of which defines the engagement formation. A further alternative is simply to manufacture the entire item as a single piece of metal.

In use, and simply by way of example, the one component (13) is adapted to have its end edge (15) fixed in secure abutment to a side face (16) of the other component (14). This end face (15), that is to be secured to the side face (16) of the other component, is provided with a semicircular recess (17) that extends inwards from what is to be the undersurface (18) of the component at what will be an inner corner and therefore not normally visible. No apertures or holes are visible in the normally exposed surfaces of the components. The recess could be concealed with a very narrow unobtrusive cover, if required.

In the assembled positions of the components this recess forms an access opening (19) for a spanner (20) preferably having an angled handle as illustrated in FIG. 6 to reach the formation (9) of the fastener. It is to be noted that the semicircular shape of the recess is significant in that such a recess can be formed using a simple drilling process in which a suitably shaped cutter is used.

As indicated above the blind holes (12) are undersized thereby causing a slight contraction of the helical formations upon being forced axially into the hole without rotation with a consequent gripping engagement between the sharp edges of the saw tooth and the wall of the hole. The joint is tightened simply by rotating the fastener in the appropriate direction using a spanner and by virtue of the opposite handed helical formations, the components are drawn tightly together (or forced apart if disassembly is required).

It is a particular feature of this invention that, if the fasteners are to be used to create permanent joints, they could be used in combination with standard dowels and adhesive in which case they can be spaced apart relative to the standard dowels appropriately with the objective of holding the components together long enough for the adhesive to cure completely. In such an instance the use of the fasteners of the invention substitutes for the use of clamps, cramps and the like and enables components to proceed along a production line whilst the adhesive cures.

This variation of fastener can be made and used in numerous other forms. Thus, as illustrated in FIGS. 8 to 10, longitudinally extending grooves (20) can be formed in the outer surface of the end regions of the fastener. The grooves serve a number of different purposes, and in particular leave longitudinally extending areas of the surface of the hole undisturbed upon being forced axially into the hole. The result is that upon subsequent rotation of the fastener the formations bite into material that has not being disturbed by the forcing of the formations into the hole. The grooves also serve to enable injection moulding or even forging of the fasteners to be effected.

FIGS. 8 to 10 also illustrate the fact that one end region could be longer than the other, this being commensurate with the longer end being anchored in the centre of a component in the plane thereof whilst the shorter end is engaged in a transverse hole extending into the thickness of the other component. The arrangement compensates for the generally varying density of thick boards of chipboard or particleboard.

FIGS. 8 to 10 still further illustrate a deformable projection (21) at each end thereof wherein the projection is dimensioned so that it forms a stop when the fastener is being forced into a hole. However, the projection is arranged to collapse under the added force created by rotation used to tighten the fastener.

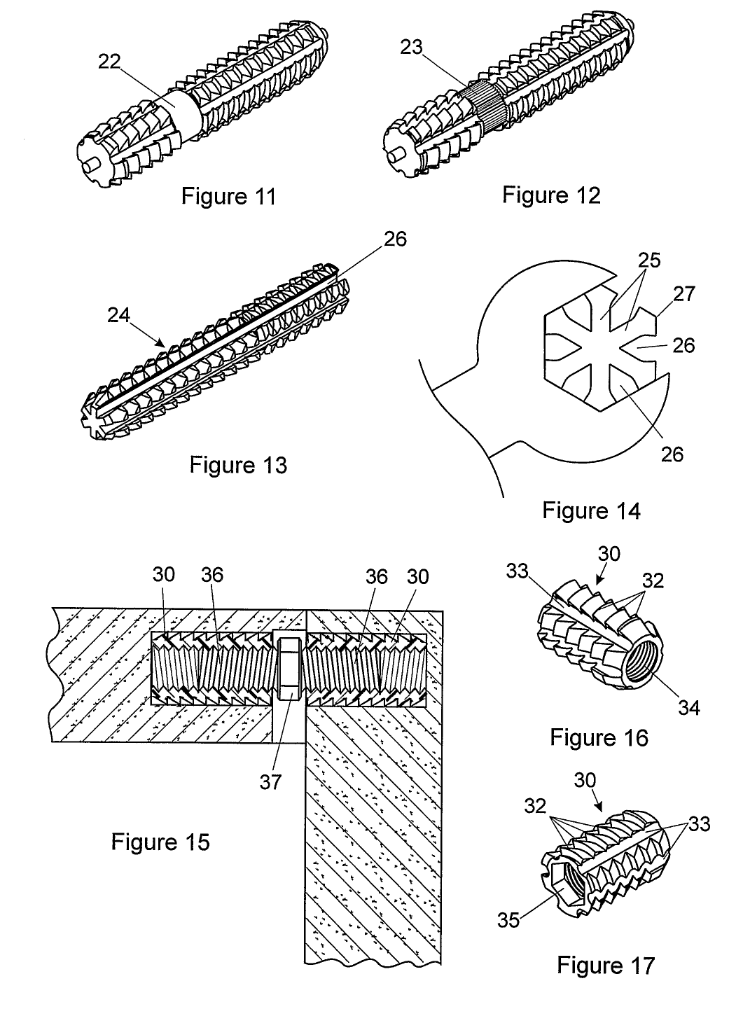

FIG. 11 illustrates a variation in which the engagement zone (22) is a plain cylindrical surface to be engaged by a tool having gripping jaws of the nature of gas pliers or a monkey wrench.

FIG. 12 illustrates a variation in which the engagement zone (23) is ribbed for cooperation with a suitable tool.

FIGS. 13 and 14 illustrate a variation of fastener (24) is machined from a metal extrusion having a cross-sectional shape clearly illustrated in FIG. 14. The section has six radiating arms (25) that define grooves (26) between them and the outer surface conforms to that of a hexagon with the corners (27) extending centrally along the outer edge of each of the arms. The helical formations that are thus continuous in view of the grooves are machined to be of opposite hands in respect of the two end regions and the engagement zone is simply formed by any appropriate zone of the outer surface as illustrated in FIG. 14. It is envisaged that use of an extruded section of this nature made from any suitable material such as aluminium, brass or steel will be highly cost effective in the production of fasteners of the invention. It is envisaged that a fastener of this nature would even be suitable for use as an orthopedic fastener in surgical procedures.

Turning now to the embodiment of the second variation of the invention that is illustrated in FIGS. 15 to 17, a fastener assembly comprises a pair of fastener elements in the form of plugs (30) each of which has an outer surface with formations (32) following a generally helical path interrupted by longitudinally extending grooves (33) very much as described above. The plug has an internally screw threaded socket (34), in this instance, of the nature of a machine screw thread. The plug also has formed at the entrance mouth thereto, an hexagonal socket formation (35) suitable for engagement by a cooperant Allen key, for example.

In this instance, a plug is inserted, as described above, into each of two blind holes by forcing the plug at least partially into the hole and thereafter rotating it to a final position in which its end adjacent the socket formation (35) is flush with the surrounding surface of the hole. A double ended screw threaded fastener (36) having oppositely handed screw threads on its end regions and a central hexagonal engagement formation (37) can then be used to draw the two components together. Alternatively, a preassembly of a pair of plugs carried on the two ends of a fastener as described can be forced into the holes followed by tightening by rotation of the fastener. It will be understood that in this instance, conventionally manufactured metal components can be used as the plugs and fastener.

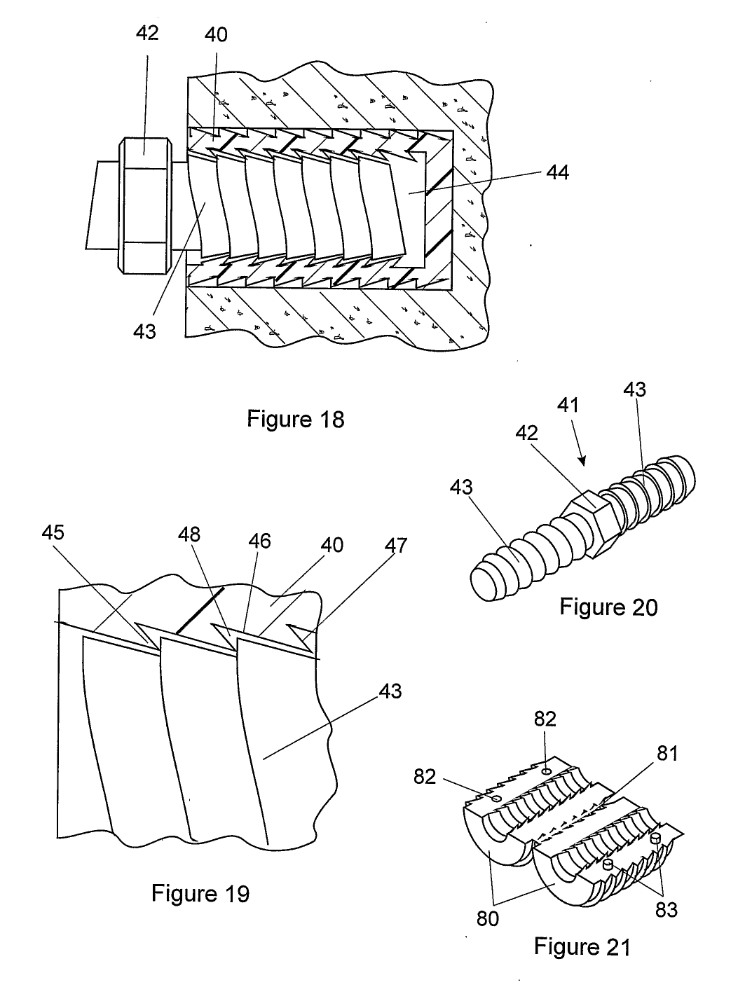

As an alternative, and as shown in FIGS. 18 and 19, the plugs (40) could be made of plastic and in this instance a fastener shank that could be exactly the same as that described with reference to FIG. 3 except that it may optionally assume the form of a turned metal fastener (41) (see FIG. 20). Such a fastener could be turned from a hexagonal section so as to thereby result in a central engagement formation (42) of larger cross-sectional size than the end regions (43).

Each plug is provided with a socket (44) for receiving an end region of the fastener shank and the inner walls of each socket are provided with helically extending screw-thread type of formations (45) extending along the length thereof.

The formations (45) of the socket wall are made to the same pitch as that of the end regions of the fastener shank but to a somewhat different shape. Thus, as shown most clearly in FIG. 19, both faces (46, 47) of this formation are inclined in the same direction so that the bulk of the formation overhangs a valley (48) between one formation and the next adjacent convolution thereof. This construction is particularly aimed at enabling the formations to flex radially outwards, away from the axis, to allow the formations on the shank to pass them as the end region of the shank is forced axially into the socket. In order to enable this to occur, the maximum outer diameter of the end region of the shank is somewhat less than the maximum inner diameter of the socket.

Once fully installed in a socket, rotation of the shank about its own axis by engaging a suitable tool with the hexagonal engagement formation will cause the shank to move further into or out of the plug and the relevant components can be drawn tightly together or forced apart, as the case may be.

The plugs can be preinstalled such that, when it is desired to assemble two such components, all that is required is for an end region of a fastener shank to be forced into each of the axially aligned plugs, and the components can be forced together in order to introduce the end regions into the associated sockets of the plugs. Once installed in this manner the joint can be tightened by rotating the hexagonal engagement formation by means of a spanner.

Numerous variations may be made to the embodiments of the invention described above without departing from the scope hereof. In particular, the second end region of the fastener shank could be adapted to be anchored in one of the components in a different manner.

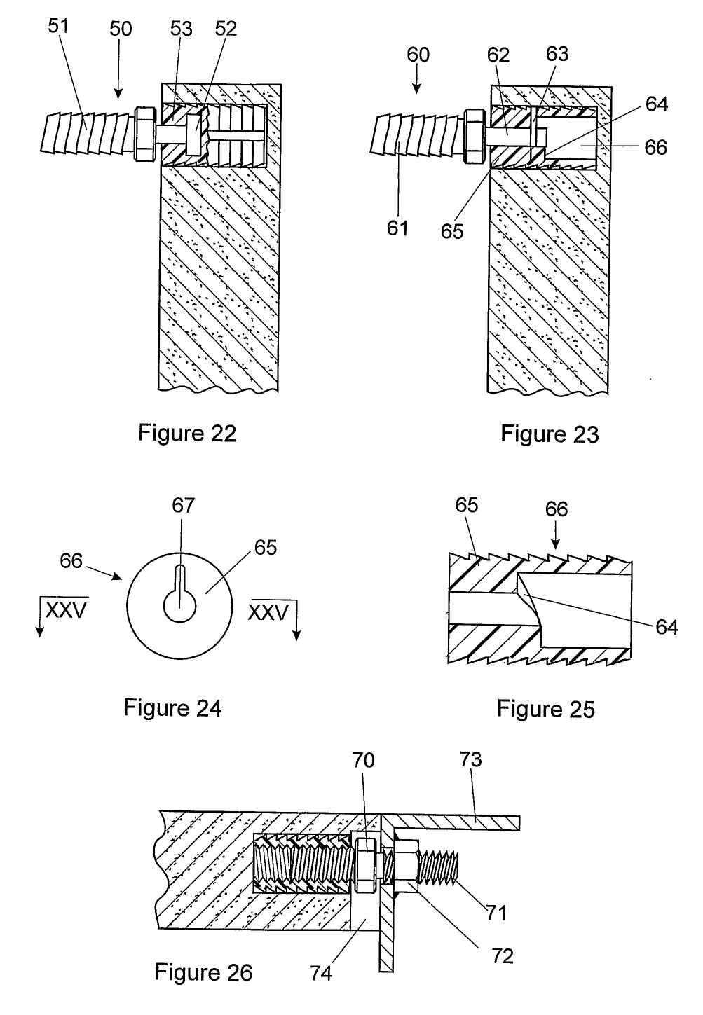

Thus, for example, as illustrated in FIG. 22, a fastener (50) could have a first end region (51) provided with helical formations as described above, and a second end of the fastener shank could have a headed portion (52) moulded into a plug (53) such that it is rotatable relative to the plug but not movable axially relative thereto. In this case tightening or loosening of a joint is effected only by movement of the first end region (51) into and out of the associated plug or hole by rotating the shank.

A further alternative is illustrated in FIG. 23 to 25 wherein a fastener (60) is provided with one end region (61) as described above.

The other end (62) of the shank is provided with a radially extending pin (63) that co-operates with a helically extending cam surface (64) on the inside of an end wall (65) of a “cam plug” (66). The end wall is provided with a keyhole shaped aperture (67) to enable the pin and end region carrying same to be introduced into the cam plug.

It is envisaged that this variation of the invention may be most advantageously applied to assemblies of components, typically knockdown type furniture, in which assembly and disassembly is to be achieved rapidly.

Finally, as illustrated in FIG. 26, a still further embodiment of the invention has a fastener (70) with its second end provided with a machine screw thread (71) for co-operation with a nut (72) or complementarily tapped hole in, for example, a metal part (73) of an article of furniture. Once again, a recess (74) is provided for access of a tool to rotate the shank. The machine screw thread and the helical formations (in this instance also a machine screw thread) on the first end region of the shank are generally of opposite hand.

It is to be mentioned that it is envisaged that plugs that are injection moulded can most easily be manufactured in two halves (80) (see FIG. 21) where the two halves are interconnected along an integral hinge type of connection (81) so that the two halves can be closed to form a complete plug and socket. Guide holes and co-operating lugs (82) and (83) can be provided on the surfaces opposite the hinge (81) that are to be abutted so that the plug can be held in its closed position should this be required.

It will be understood that numerous variations may be made to the embodiments of the invention described above without departing from the scope hereof.

1. A fastener adapted to be secured in a blind hole formed in a first component to be connected to a second component, said fastener comprising:
an element is of generally cylindrical shape with an outer surface; and
a series of anchoring formations extending along at least a part of a length of the outer surface, wherein the formations are configured to enable the element to be forcibly introduced, at least partially, without rotation thereof, axially into the blind hole in said first component to anchor the element therein,
the element comprising either a shank permanently associated therewith or one or more formations for the operative retention of a cooperant end of a separate shanks,
wherein the anchoring formations follow a generally helical path and wherein an engagement zone is provided on the element or a the shank associated therewith for engagement by a tool whereby rotation of the element about its axis can be effected to cause said anchoring formations to follow a helical path in the blind hole with resultant axial movement of the element relative to the blind hole to move the element axially in the hole.

2. A fastener as claimed in claim 1 in which the element forms part of a fastener comprising a shank having a first end region permanently associated therewith and a second end region provided with an anchor comprising at least one retaining formation configured to enable the second end region to be anchored in a blind hole in a second component in order to join the said first and second components together.

3. A fastener element as claimed in claim 2 in which the anchor is in the form of a second of said fasteners wherein the helical path is of opposite hand to that of the first fastener.

4-14. (canceled)

15. A fastener as claimed in claim 2 in which said anchor comprises a retaining formation in the form of a head held axially relative to a second plug for anchoring in a hole in a second component but wherein the shank is rotatable relative to the second plug.

16. A fastener as claimed in claim 2 in which said anchor includes a retaining formation in the form of a conventional machine screw-thread optionally of opposite hand to any helically extending formation on the said first end of the shank and capable of cooperation with a nut associated with a second component.

17. A fastener as claimed in claim 2 in which said anchor includes a retaining formation in the form of a radially extending formation co-operating with a cam surface on the inside of a plug in a hole in a second component.

18. A fastener as claimed in claim 1 in which the engagement zone is integral with the anchoring formations on the element.

19. A fastener as claimed in claim 1 in which the engagement zone is an exposed part of an elongate insert onto which material is moulded in order to form the anchoring formations in which case the elongate insert is configured for engagement by a cooperant tool.

20. A fastener as claimed in claim 1 in which the fastener element assumes the form of a plug for installation in a blind hole in a component and wherein the engagement formations are one or more formations in a face thereof that is to be operatively exposed at the mouth of the blind hole.

21. A fastener as claimed in claim 20 in which the socket has formations selected from a screw thread and deformable projections configured to retain a cooperating end of a shank therein.

22. A fastener as claimed in claim 21 in which the formations are deformable projections in the form of a substantially continuous helical formation of saw-tooth shape with the saw tooth shape providing an undercut to render the formation capable of flexing to a somewhat flattened condition as another set of formations is urged axially past them.

23. A fastener as claimed in claim 1 in which the anchoring formations are configured for cooperation with the walls of blind holes drilled in somewhat soft or deformable material.

24. A fastener as claimed in claim 1 in which the anchoring formations are a series of convolutions of a continuous or discontinuous helical formation of generally saw tooth shape in longitudinal section.

25. A fastener as claimed in claim 24 in which the series of convolutions is discontinuous by virtue of longitudinally extending grooves in the outer surface of the fastener.

26. A method of connecting two components to be joined wherein the components are provided with appropriate aligned blind holes for receiving a fastener or an end region of a fastener having an element having a series of formations permitting it to be forcibly introduced, at least partially, without rotation thereof, axially into the blind hole in each of said components to anchor the fastener therein,
wherein the anchoring formations follow a generally helical path such that rotation of the element about its axis operatively causes said anchoring formations to follow a helical path in the blind hole with resultant axial movement of the element relative to the blind hole to move the element axially in the hole and
wherein an engagement zone is provided on the element or a shank associated therewith for engagement by a tool intermediate the ends of the fastener
wherein at least one of such components is provided with a recess or hole for defining an access aperture in the assembled condition of the components,
the method comprising installing the fastener in said aligned holes by urging the components towards each other to force the elements into the blind holes axially without rotation thereof;
and then tightening the resultant joint by rotation of the fastener or shank, in each case by engaging a tool with said engagement zone by way of the access aperture.

27. A method as claimed in claim 26 in which the two components are provided with additional conventional aligned holes for receiving conventional dowels in which case the method involves the application of adhesive and assembly of the components using fasteners of this invention to urge the components into firm engagement with each other so that curing of the adhesive may take place.
